(19) United States
(12) Patent Application Publication
(10) Pub. No.: US 2022/0252965 A1
(43) Pub. Date: Aug. 11, 2022

(54) BRACKET-TYPE CAMERA DEVICE

(71) Applicant: JIANGXI OUMAISI MICROELECTRONICS CO., LTD., Nanchang (CN)

(72) Inventors: Xianyun TU, Nanchang (CN); Hua CHEN, Nanchang (CN); Nan CHEN, Nanchang (CN)

(73) Assignee: JIANGXI OUMAISI MICROELECTRONICS CO., LTD., Nanchang (CN)

(21) Appl. No.: 17/622,806

(22) PCT Filed: Oct. 21, 2019
(86) PCT No.: PCT/CN2019/112078

§ 371 Date: Dec. 25, 2021

(30) Foreign Application Priority Data
Jul. 18, 2019 (CN) 2019 10648923.0

(51) Int. Cl. G03B 17/56; F16M 11/08

(52) U.S. Cl. CPC G03B 17/561; F16M 11/08

(57) ABSTRACT

A bracket-type camera device comprises: a bracket extending along the vertical direction; a first camera module arranged on the bracket; a second camera module arranged on the bracket, and spaced from the first camera module in the vertical direction; the first camera module and the second camera module respectively have at least two rotation modes of left and right rotation and up and down rotation relative to the bracket, the axis of the left and right rotation of the first camera module is parallel to the vertical direction, the axis of the up and down rotation of the first camera module is perpendicular to the vertical direction; the axis of the left and right rotation of the second camera module is parallel to the vertical direction the axis of the up and down rotation of the second camera module is perpendicular to the vertical direction.

### CROSS-REFERENCE TO RELATED APPLICATION

This application is a national stage, filed under 35 U.S.C. § 371, of International Application No. PCT/CN2019/112078, filed on Oct. 21, 2019, and entitled “BRACKET-TYPE CAMERA DEVICE”, which claims to the priority of a Chinese Patent Application No. 2019106489230, filed on Jul. 18, 2019.

### TECHNICAL FIELD

The present disclosure relates to the field of camera technology, in particular to a stand-type camera device.

### BACKGROUND

When handling business in banks, insurance companies, municipal halls and other places, it is necessary to use a camera device with a bidirectional video recording function to record videos for customers and staffs respectively to monitor and control business handling. The camera device generally includes a first camera module and a second camera module that are integrated and have camera ends opposite to each other. The first camera module is used for video recording of the staff, and the second camera module is used for video recording of the customer. However, the conventional camera device has a poor angle adjusting function, and it is prone to a situation that the position of the customer or the staff deviates from the position within a preset range such that the complete video recording is not possible.

### SUMMARY

According to various embodiments of the present disclosure, a stand-type camera device is provided.

A stand-type camera device includes:

a stand extending in an up-down direction;

a first camera module disposed on the stand; and

a second camera module disposed on the stand, and spaced apart from the first camera module in the up-down direction.

The first camera module has at least two rotation modes of left-right rotation and up-down rotation relative to the stand. A first rotation axis around which the first camera module rotates left and right is parallel to the up-down direction. A second rotation axis around which the first camera module rotates up and down is perpendicular to the up-down direction.

The second camera module has at least two rotation modes of left-right rotation and up-down rotation relative to the stand. A third rotation axis around which the second camera module rotates left and right is parallel to the up-down direction. A fourth rotation axis around which the second camera module rotates up and down is perpendicular to the up-down direction.

A stand-type camera device includes:

a stand;

a first camera module disposed on the stand, and capable of rotating around a first rotation axis and a second rotation axis relative to the stand, respectively; the first rotation axis forming a first preset angle with the second rotation axis, the first rotation axis being not parallel to the second rotation axis; and

a second camera module disposed on the stand, and spaced apart from the first camera module, wherein the second camera module is capable of rotating around a third rotation axis and a fourth rotation axis relative to the stand, respectively; the third rotation axis forms a second preset angle with the fourth rotation axis, and the third rotation axis is not parallel to the fourth rotation axis.

Details of one or more embodiments of the present disclosure will be given in the following description and attached drawings. Other features, objects and advantages of the present disclosure will become apparent from the description, drawings, and claims.

### BRIEF DESCRIPTION OF THE DRAWINGS

In order to better describe and illustrate the embodiments and/or examples of the contents disclosed herein, reference may be made to one or more drawings. Additional details or examples used to describe the drawings should not be considered as limiting the scope of any of the disclosed contents, the currently described embodiments and/or examples, and the best mode of these contents currently understood.

FIG. 1 is a perspective schematic view of a stand-type camera device according to an embodiment of the present disclosure.

FIG. 2 is a front view of an object-side end of a first camera module of the stand-type camera device shown in FIG. 1.

FIG. 3 is a front view of an object-side end of a second camera module of the stand-type camera device shown in FIG. 1.

FIG. 4 is a perspective schematic view of a first camera module shown in FIG. 1 when being assembled with a first connecting structure.

FIG. 5 is a perspective schematic view of the first connecting structure of which a portion is removed shown in FIG. 4.

FIG. 6 is an exploded view of FIG. 4.

FIG. 7 is a front view of a first mating portion and a first arc-shaped damping portion shown in FIG. 1.

FIG. 8 is a cross-sectional view taken along a line E-E in FIG. 7.

FIG. 9 is an exploded view of a second camera module shown in FIG. 1.

FIG. 10 is a partial exploded view of FIG. 9.

FIG. 11 is a partial exploded view of FIG. 9 in a first perspective.

FIG. 12 is a partial exploded view of FIG. 9 in a second perspective.

### DETAILED DESCRIPTION OF THE EMBODIMENTS

In order to facilitate the understanding of the present disclosure, the present disclosure will be described in a more comprehensive manner with reference to the relevant drawings. Exemplary embodiments of the present disclosure are shown in the drawings. However, the present disclosure can be implemented in many different forms and is not limited to the embodiments described herein. On the contrary, the purpose of providing these embodiments is to make the disclosure of the present disclosure more thorough and comprehensive.

It should be noted that when an element is referred to as being “fixed to” another element, it can be directly on another element or an intermediate element may be present. When an element is considered to be “connected to” another element, it can be directly connected to another element or an intermediate element may be present at the same time. Terms “vertical”, “horizontal”, “left”, “right” and similar expressions used herein are for illustrative purposes only.

Unless otherwise defined, all technical and scientific terms used herein have the same meaning as commonly understood by those skilled in the technical field of the present disclosure. The terms used in the description of the present disclosure herein are only for the purpose of describing specific embodiments, and are not intended to limit the present disclosure. As used herein, the term “and/or” includes any and all combinations of one or more associated listed items.

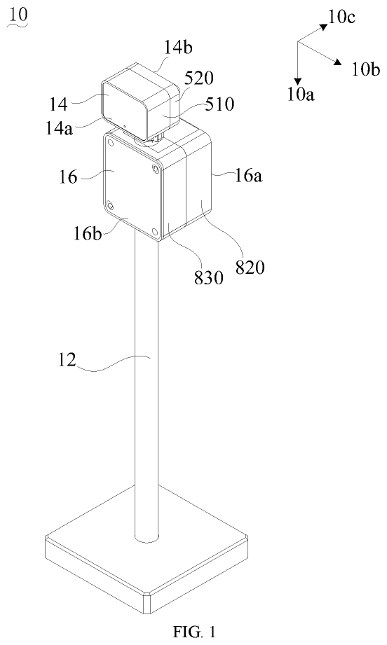

As shown in FIG. 1, according to an embodiment of the present disclosure, a stand-type camera device 10 is provided. The stand-type camera device 10 includes a stand 12 and a first camera module 14 and a second camera module 16 that are disposed on the stand 12. In some embodiments, the stand 12 extends in an up-down direction 10a, and the first camera module 14 and the second camera module 16 are arranged at an interval in the up-down direction 10a. As such, it is very convenient to independently adjust the capturing angle of the first camera module 14 or the second camera module 16. That is, when the capturing angle of one camera module is adjusted, the capturing angle of the other camera module is not affected.

It should be noted that the up-down direction 10a, a left-right direction 10b, and a front-rear direction 10c are perpendicular to each other. The front-rear direction 10c is a direction when the user faces an object-side end 14a of the first camera module 14 or an object-side end 16a of the second camera module 16.

In this embodiment, the object-side end 14a of the first camera module 14 refers to an end of the first camera module 14 for collecting images of a subject, that is, an end where a light incident surface of the first camera module 14 is located. The object-side end 16a of the second camera module 16 refers to an end of the second camera module 16 for collecting images of a subject, that is, an end where a light incident surface of the second camera module 16 is located. In addition, the object-side end 14a of the first camera module 14 and the object-side end 16a of the second camera module 16 are disposed opposite to each other. In addition, in this embodiment, the first camera module 14 further has an image-side end 14b. The image-side end 14b is an end where a photosensitive chip of the first camera module 14 is located, and is used for imaging and is disposed opposite to the object-side end 14a. The second camera module 16 further has an image-side end 16b. The image-side end 16b is an end where a photosensitive chip of the second camera module 16 is located, and is used for imaging, and is disposed opposite to the object-side end 16a.

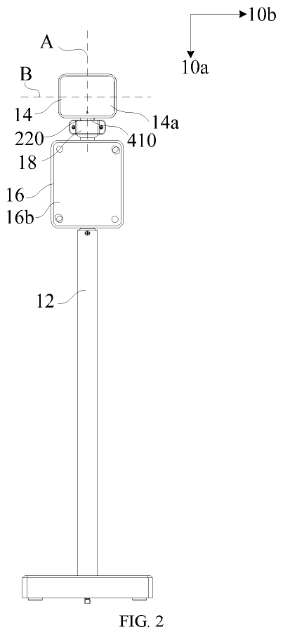

In some embodiments, as shown in FIG. 2, the first camera module 14 has two rotation modes of left-right rotation and up-down rotation relative to the stand 12. As such, the stand-type camera device 10 can have a function of adjusting the capturing angle. A first rotation axis A around which the first camera module 14 rotates left and right is parallel to the up-down direction 10a. A second rotation axis B around which the first camera module 14 rotates up and down is perpendicular to the up-down direction 10a. In some embodiments, the first rotation axis A for left-right rotation and the second rotation axis B for up-down rotation are both parallel to an end surface of the object-side end 14a of the first camera module 14. In this case, the second rotation axis B for the up-down rotation is parallel to the left-right direction 10b.

In this embodiment, the up-down direction 10a, the left-right direction 10b, and the front-rear direction 10c form a spatial coordinate system. The left-right rotations of the first camera module 14 and the second camera module 16 are actually a rotation around the up-down direction 10a. The up-down rotations of the first camera module 14 and the second camera module 16 are actually a rotation around the left-right direction 10b. That is, the second rotation axis B is further perpendicular to a direction from the object-side end 14a of the first camera module 14 to the image-side end 14b of the first camera module 14, and a fourth rotation axis is further perpendicular to a direction from the object-side end 16a of the second camera module 16 to the image-side end 16b of the second camera module 16.

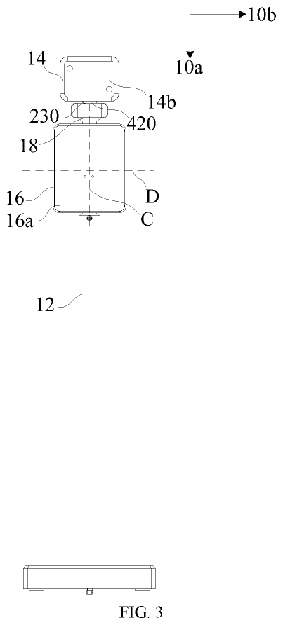

In some embodiments, as shown in FIG. 3, the second camera module 16 has two rotation modes of left-right rotation and up-down rotation relative to the stand 12. A third rotation axis C around which the second camera module 16 rotates left and right is parallel to the up-down direction 10a. A fourth rotation axis D around which the second camera module 16 rotates up and down is perpendicular to the up-down direction 10a. In some embodiments, the third rotation axis C for left-right rotation and the fourth rotation axis D for up-down rotation are both parallel to an end surface of the image-side end 16a of the second camera module 16. In this case, the fourth rotation axis D for the up-down rotation is parallel to the left-right direction 10b.

That is, in some embodiments, both the first camera module 14 and the second camera module 16 have two rotation modes of left-right rotation and up-down rotation relative to the stand 12. As such, the capturing angle of the stand-type camera device 10 can be adjusted more flexibly. In some other embodiments, one of the first camera module 14 and the second camera module 16 is fixed relative to the stand 12, and the other one has two rotation modes of left-right rotation and up-down rotation relative to the stand 12. In some other embodiments, one of the first camera module 14 and the second camera module 16 has a rotation mode (one rotation mode) of left-right rotation or up-down rotation relative to the stand 12, and the other one has two rotation modes of left-right rotation and up-down rotation relative to the stand 12.

In some embodiments, the maximum left rotation angle and the maximum right rotation angle of the first camera module 14 relative to the stand 12 are the same. The maximum upward rotation angle and the maximum downward rotation angle of the first camera module 14 relative to the stand 12 are the same. As such, it is very convenient to symmetrically design a connecting structure connecting the first camera module 14 and the stand 12.

In some embodiments, the maximum left rotation angle and the maximum right rotation angle of the second camera module 16 relative to the stand 12 are the same. The maximum upward rotation angle and the maximum downward rotation angle of the second camera module 16 relative to the stand 12 are the same. As such, it is very convenient to symmetrically design a connecting structure connecting the second camera module 16 and the stand 12.

In some embodiments, the second rotation axis B is parallel to the fourth rotation axis C. In this case, the object-side end 14a of the first camera module 14 and the image-side end 16a of the second camera module 16 may be located on the same side of the stand 12, or may be located on opposite sides of the stand 12. In some embodiments, the object-side end 14a of the first camera module 14 and the image-side end 16a of the second camera module 16 are located on opposite sides of the stand 12. As such, it is very convenient to capture two opposite subjects respectively. For example, when handling business in a bank, the customer and the staff (two subjects) sit opposite to each other, and the stand-type camera device 10 is placed between the customer and the staff. The object-side end 14a of the first camera module 14 is directly opposite to the staff and is used to capture the staff, and the object-side end 16a of the second camera module 16 is directly opposite to the customer and is used to capture the customer.

In some embodiments, the maximum left rotation angle of the first camera module 14 relative to the stand 12 is the same as the maximum left rotation angle of the second camera module 16 relative to the stand 12, and the maximum right rotation angle of the first camera module 14 relative to the stand 12 is the same as the maximum right rotation angle of the second camera module 16 relative to the stand 12. The maximum upward rotation angle of the first camera module 14 relative to the stand 12 is the same as the maximum upward rotation angle of the second camera module 16 relative to the stand 12, and the maximum downward rotation angle of the first camera module 14 relative to the stand 12 is the same as the maximum downward rotation angle of the second camera modules 16 relative to the stand 12. As such, the connecting structure connecting the first camera module 14 and the stand 12 can be the same as the connecting structure connecting the second camera module 16 and the stand 12, which is beneficial to reduce the design and developing cost of the stand-type camera device 10 (designing two different connecting structures would increase the design and developing cost), and can further make the adjusting range of the capturing angles of the two subjects substantially the same.

In some embodiments, both the maximum left rotation angle and the maximum right rotation angle of the first camera module 14 relative to the stand 12 are 45°, and both the maximum upward rotation angle and the maximum downward rotation angle of the first camera module 14 relative to the stand 12 are 5°. Both the maximum left rotation angle and the maximum right rotation angle of the second camera module 16 relative to the stand 12 are 45°, and both the maximum upward rotation angle and the maximum downward rotation angle of the second camera module 16 relative to the stand 12 are 5°. As such, it is possible to meet the requirements for adjusting the capturing angles of the two opposite subjects, and to avoid the increase in design cost caused by the adjustment of the capturing angles in a larger range.

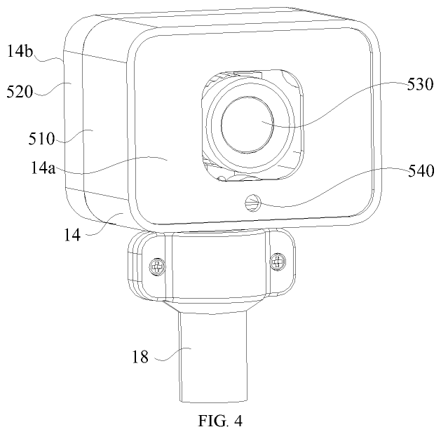

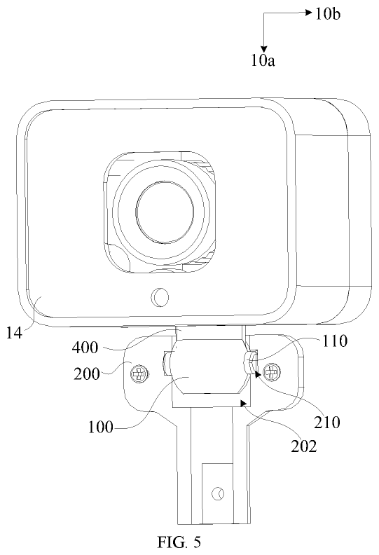

In some embodiments, as shown in FIGS. 2 and 3, the stand-type camera device 10 further includes a first connecting structure 18. The first connecting structure 18 connects the first camera module 14 and the stand 12. As shown in FIGS. 4 and 5, the first connecting structure 18 includes a first spherical portion 100 and a first mating portion 200. The first spherical portion 100 is disposed on one of the first camera module 14 and the stand 12. The first mating portion 200 is disposed on the other one of the first camera module 14 and the stand 12.

The first mating portion 200 is provided with a cylindrical accommodating groove 202 extending in the up-down direction 10a. The first spherical portion 100 is accommodated in the cylindrical accommodating groove 202. The first spherical portion 100 can rotate left and right around the first rotation axis A and rotate up and down around the second rotation axis B in the cylindrical accommodating groove 202. As such, it is very convenient to realize the left-right rotation and the up-down rotation of the first camera module 14 relative to the stand 12, and further enables positions of the first spherical portion 100 and the cylindrical accommodating groove 202 to be relatively fixed in the up-down direction 10a.

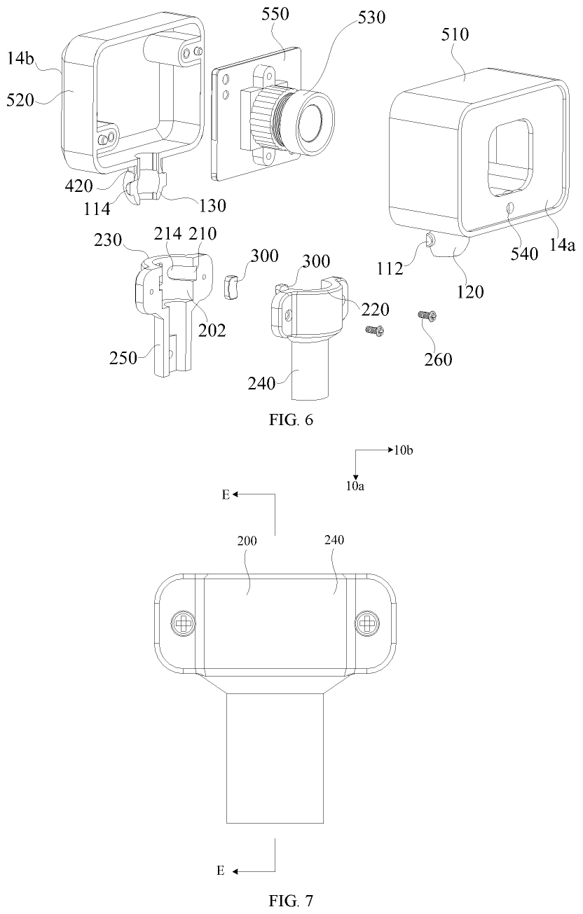

In some embodiments, as shown in FIGS. 6 to 8, the first connecting structure 18 further includes a plurality of first arc-shaped damping portions 300. The plurality of first arc-shaped damping portions 300 are disposed on an inner wall of the cylindrical accommodating groove 202 at intervals along a circumferential direction. The plurality of first arc-shaped damping portions 300 abut against the first spherical portion 100, so that there is a pre-tightening force between the first spherical portion 100 and the cylindrical accommodating groove 202. The first arc-shaped damping portion 300 can apply a certain pre-tightening force to the first spherical portion 100. That is, the first spherical portion 100 does not rotate due to lighter external forces such as gravity, during the left-right rotation around the first rotation axis A and the up-down rotation around the second rotation axis B in the cylindrical accommodating groove 202, and the position of the first spherical portion 100 after the rotation is completed can be maintained stable after the rotation is controlled manually or mechanically. In some embodiments, the first arc-shaped damping portion 300 is a damping silicon. In some embodiments, two first arc-shaped damping portions 300 are provided. The two first arc-shaped damping portions 300 are symmetrically provided about the first rotation axis A.

In some embodiments, the inner wall of the cylindrical accommodating groove 202 is provided with an arc-shaped groove 210. The first spherical portion 100 is provided with a sliding portion 110. An end of the sliding portion 110 away from the first spherical portion 100 is located in the arc-shaped groove 210. The inner walls at both ends of the arc-shaped groove 210 are a first left limiting portion 212 and a first right limiting portion 214, respectively. During that the first camera module 14 rotates left and right around the first rotation axis A relative to the stand 12, when the sliding portion 110 abuts against the first left limiting portion 212, the first camera module 14 is in a state of the maximum left rotation angle, and when the sliding portion 110 abuts against the first right limiting portion 214, the first camera module 14 is in a state of the maximum right rotation angle.

In the above configuration, the cooperation of the sliding portion 110 and the arc-shaped groove 210 is beneficial not only to control the rotation angle range of the left-right rotation, but also to relatively fixation of the positions of the first spherical portion 100 and the cylindrical accommodating groove 202 in the up-down direction 10a. In some embodiments, the upper and lower outer walls of the sliding portion 110 are respectively in contact with the upper and lower inner walls of the arc-shaped groove 210. That is, the outer diameter of the sliding portion 110 in the up-down direction 10a is substantially the same as the inner diameter of the arc-shaped groove 210 in the up-down direction 10a. Thus, the positions of the first spherical portion 100 and the cylindrical accommodating groove 202 in the up-down direction 10a are relatively fixed.

In some embodiments, two arc-shaped grooves 210 are provided. The two arc-shaped grooves 210 are symmetrically provided about the first rotation axis A. Two sliding portions 110 are provided. The two sliding portions 110 are symmetrically provided about the first rotation axis A. The arrangement direction of the two arc-shaped grooves 210 is perpendicular to the arrangement direction of the two first arc-shaped damping portions 300.

In some embodiments, the first connecting structure 18 further includes a first cylinder 400. The first cylinder 400 connects the first camera module 14 and the first spherical portion 100. The first mating portion 200 is provided on the stand 12. Front and rear edges of the first mating portion 200 are a first lower limiting portion 220 and a first upper limiting portion 230, respectively. During that the first camera module 14 rotates up and down around the second rotation axis B relative to the stand 12, when the first camera module 14 abuts against the first lower limiting portion 220, the first camera module 14 is in a state of the maximum downward rotation angle, and when the first camera module 14 abuts against the first upper limiting portion 230, the first camera module 14 is in a state of the maximum upward rotation angle.

In some embodiments, as shown in FIGS. 2 and 6, the first cylinder 400, the first spherical portion 100, and the first mating portion 200 all have a hollow structure. In addition, the first cylinder 400, the first spherical portion 100, the sliding portion 110, and the first mating portion 200 are formed by detachable splicing two symmetrical portions. In this way, it is very convenient to disassemble and assemble, and it is convenient for the first camera module 14 to use the hollow structure to route and wire.

In some embodiments, the first camera module 14 includes the first object-side end 14a and the first image-side end 14b opposite to the first object-side end 14a. The first camera module 14 includes a first housing. The first housing includes a first object-side housing unit 510 and a second image-side housing unit 520 that are detachably connected. The first object-side housing unit 510 and the second image-side housing unit 520 are arranged in a direction from the first object-side end 14a to the first image-side end 14b. The two symmetrical portions of the first cylinder 400 are an object-side cylinder unit 410 and an image-side cylinder unit 420, respectively. The object-side cylinder unit 410 and the image-side cylinder unit 420 are arranged in the direction from the first object-side end 14a to the first image-side end 14b. The two symmetrical portions of the first spherical portion 100 are an object-side spherical unit 120 and an image-side spherical unit 130, respectively. The object-side spherical unit 120 and the image-side spherical unit 130 are arranged in the direction from the first object-side end 14a to the first image-side end 14b. The two symmetrical portions of the sliding portion 110 are an object-side sliding unit 112 and an image-side sliding unit 114, respectively. The object-side sliding unit 112 and the image-side sliding unit 114 are arranged in the direction from the first object-side end 14a to the first image-side end 14b.

The first object-side housing unit 510, the object-side cylinder unit 410, the object-side spherical unit 120, and the object-side sliding unit 112 are integrally formed. The second image-side housing unit 520, the image-side cylinder unit 420, and the image-side spherical unit 130, and the image-side sliding unit 114 are integrally formed.

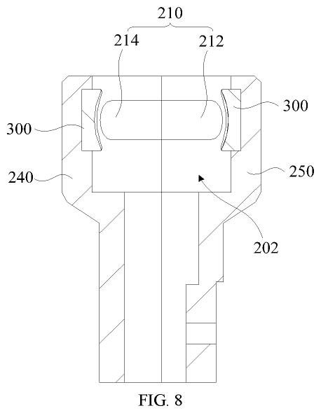

In some embodiments, as shown in FIGS. 6 and 8, the two symmetrical portions of the first mating portion 200 are arranged in the front-rear direction 10c. The two symmetrical portions of the first mating portion 200 are a front mating unit 240 and a rear mating unit 250, respectively. Two ends of the arc-shaped groove 210 are respectively located on the front mating unit 240 and the rear mating unit 250.

In some embodiments, the first cylinder 400, the first spherical portion 100, the first mating portion 200, and the stand 12 all have a hollow structure. The first camera module 14, the first cylinder 400, the first spherical portion 100, the first mating portion 200, and the stand 12 are sequentially connected for routing of the first camera module 14.

In some embodiments, as shown in FIGS. 6 and 8, two first arc-shaped damping portions 300 are provided. The two first arc-shaped damping portions 300 are respectively provided on the front mating unit 240 and the rear mating unit 250. The two first arc-shaped damping portions 300 are arranged in the front-rear direction 10c.

In some embodiments, as shown in FIG. 6, the first camera module 14 further includes a first lens assembly 530 disposed in the first housing. In some embodiments, the first lens assembly 530 is a visible light camera assembly. In some embodiments, the first camera module 14 further includes a first microphone 540 disposed in the first housing. As such, the first camera module 14 has both a capturing function and a sound recording function. In some embodiments, the first camera module 14 further includes a speaker disposed in the first housing. As such, the first camera module 14 can further have a voice function. In some embodiments, the first lens assembly 530, the first microphone 540, the first speaker, etc. are all integrated on a first main board 550.

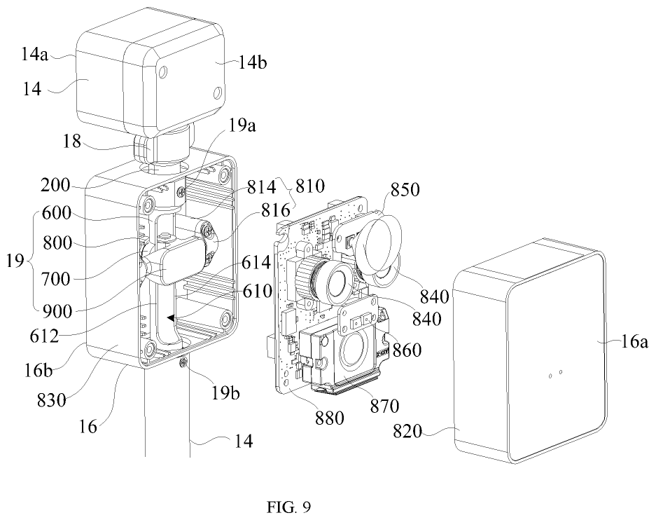

In some embodiments, as shown in FIG. 9, the stand-type camera device 10 further includes a second connecting structure 19. The second connecting structure 19 connects the first connecting structure 18 and the stand 12. The second camera module 16 is sleeved on the second connecting structure 19.

In some embodiments, the end of the first mating portion 200 away from the first spherical portion 100 is connected to the second connecting structure 19. Specifically, in some embodiments, the second connecting structure 19 has a hollow structure. The end of the first mating portion 200 away from the first spherical portion 100 is inserted into the second connecting structure 19 (that is, the first mating portion 200 is fitted into the second connecting structure 19 through a shaft hole), and is fixed by a screw 19a on the side.

In some embodiments, the stand 12 has a hollow structure. An end of the second connecting structure 19 away from the first connecting structure 18 is inserted into the stand 12 (that is, the second connecting structure 19 is fitted into the stand 12 through a shaft hole), and is fixed by a screws 19b on the side.

In some embodiments, as shown in FIGS. 9 to 11, the second connecting structure 19 includes a second cylinder 600, a second spherical portion 700, and a second arc-shaped damping portion 800. Two ends of the second cylinder 600 are connected to the first mating portion 200 and the stand 12, respectively. The second camera module 16 is sleeved on the second cylinder 600. The second spherical portion 700 and the second arc-shaped damping portion 800 are located in the second camera module 16. The second spherical portion 700 is disposed on one of the second camera module 16 and the second cylinder 600. The second arc-shaped damping portion 800 is disposed on the other one of the second camera module 16 and the second cylinder 600. The second spherical portion 700 abuts against the second arc-shaped damping portion 800, so that there is a pre-tightening force between the second camera module 16 and the second cylinder 600. The second camera module 16 rotates left and right around the third rotation axis C and rotates up and down around the fourth rotation axis D through the second spherical portion 700 and the second arc-shaped damping portion 800. As such, it is very convenient to realize the left-right rotation and the up-down rotation of the second camera module 16 relative to the stand 12.

In some embodiments, the second arc-shaped damping portion 800 is a damping silicon.

In some embodiments, the second spherical portion 700 is disposed on the second cylinder 600, and the second arc-shaped damping portion 800 is disposed on the second camera module 16.

In some embodiments, the second connecting structure 19 further includes a rotating shaft mechanism 900. The rotating shaft mechanism 900 includes a first rotating shaft 910 and a second rotating shaft 920. The first rotating shaft 910 is fixed on a side of the second cylinder 600 away from the second spherical portion 700. The first rotating shaft 910 extends in the up-down direction 10a. That is, an axial direction of the first rotating shaft 910 is parallel to the up-down direction 10a. The second rotating shaft 920 is sleeved on the first rotating shaft 910 and can rotate left and right around the third rotating axis C relative to the first rotating shaft 910. An extending direction of the second rotating shaft 920 is perpendicular to the up-down direction 10a. Both ends of the second rotating shaft 920 extend to the left and right sides of the second cylinder 600, and both ends of the second rotating shaft 920 are rotatably connected to the second camera module 16, so that the second spherical portion 700 abuts against the second arc-shaped damping portion 800. The second camera module 16 can rotate up and down around the fourth rotation axis D relative to the second rotation rotating shaft 920.

In some embodiments, the second cylinder 600 has a hollow structure. A side wall of the second cylinder 600 opposite to the second spherical portion 700 is provided with a gap 610, and forms a second left limiting portion 612 and a second right limiting portion 614. The first rotating shaft 910 is disposed in the second cylinder 600 and exposed at the gap 610. Both ends of the second rotating shaft 920 respectively extend to the outside of the second left limiting portion 612 and the second right limiting portion 614. During that the second camera module 16 rotates left and right around the third rotation axis C relative to the stand 12, when the second rotating shaft 920 abuts against the second left limiting portion 612, the second camera module 16 is in a state of the maximum left rotation angle, and when the second rotating shaft 920 abuts against the second right limiting portion 614, the second camera module 16 is in a state of the maximum right rotation angle.

In some embodiments, the rotating shaft mechanism 900 further includes a fixed portion 930 and a rotating portion 940. The fixed portion 930 is fixed in the second cylinder 600 and exposed at the gap 610. The first rotating shaft 910 extends through the fixed portion 930. The rotating portion 940 is disposed on the second rotating shaft 920. The rotating portion 940 extends through the first rotating shaft 910. The rotating portion 940 can rotate left and right around the third rotating axis C relative to the first rotating shaft 910. As such, it is very convenient to mount the first rotating shaft 910 and the second rotating shaft 920. In some embodiments, two rotating portions 940 are provided. The fixed portion 930 is located between the two rotating portions 940.

Specifically, in this embodiment, the first rotating shaft 910 is a three-step shaft, in which a diameter of a middle portion (i.e., the fixed portion 930) is larger than diameters of portions at the two ends (the diameters of portions at the two ends may be the same). The fixed portion 930 is fixed in the second cylinder 600, specifically on the side wall of the second cylinder 600 opposite to the gap 610. A middle portion of the second rotating shaft 920 has two lugs, that is, rotating portions 940. The two rotating portions are provided with mating holes. The portions at two ends of the first rotating shaft 910 are respectively cooperated with the two mating holes to realize the rotational connection between the second rotating shaft 920 and the first rotating shaft 910. In addition, the portions at both end of the second rotating shaft 920 are used for the rotating shaft to cooperate with corresponding holes on the second camera module 16 to realize the rotational cooperation between the second camera module 16 and the second rotating shaft 920.

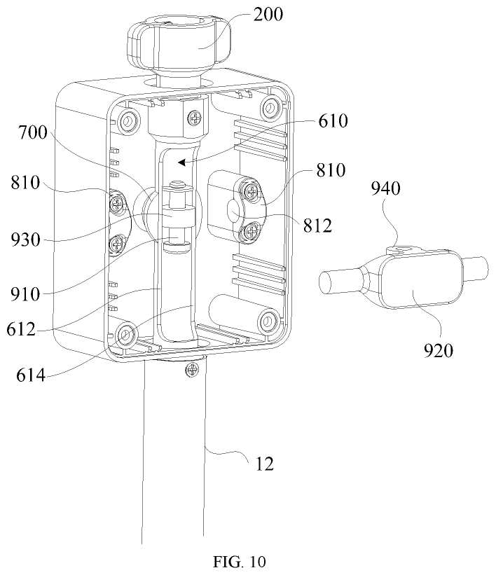

In some embodiments, as shown in FIG. 10, a second mating portion 810 is further provided in the second camera module 16. The second mating portion 810 is provided with a mating hole 812. Two second mating portions 810 are provided. Two ends of the second rotating shaft 920 are respectively inserted into the mating holes 812 of the two second mating portions 810 and are rotatably connected to the second mating portions 810. The second mating portion 810 can rotate up and down around the fourth rotation axis D relative to the second rotating shaft 920. As such, the structure can be more stable.

In some embodiments, the second arc-shaped damping portion 800 is located between the two second mating portions 810. The second arc-shaped damping portion 800 and the two second mating portions 810 are arranged in a first straight line perpendicular to the up-down direction 10a. The fixed portion 930 and the second spherical portion 700 are arranged in a second straight line perpendicular to the up-down direction 10a. The second straight line intersects the first straight line. As such, the structure can be more stable.

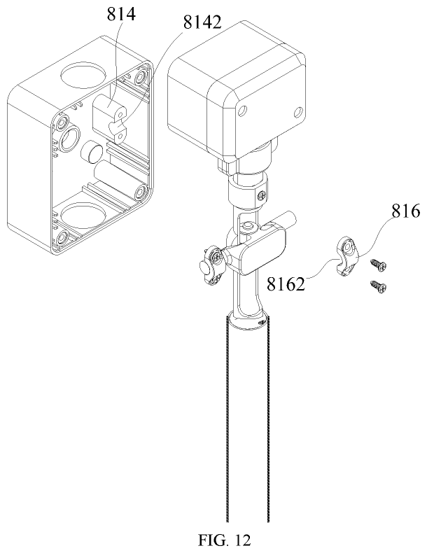

As shown in FIG. 12, in some embodiments, the second mating portion 810 includes a mounting seat 814 disposed in the second camera module 16 and a cover plate 816 detachably connected to the mounting seat 814. An end surface of the mounting seat 814 is provide with a first groove 8142. The cover plate 816 is provided with a second groove 8162. The first groove 8142 cooperates with the second groove 8162 to form a mating hole 812. As such, it is very easy to disassemble and assemble. In some embodiments, the mounting seat 814 and the cover plate 816 are fixed by a screw.

In some embodiments, as shown in FIG. 9, the second camera module 16 includes a second object-side end 16a and a second image-side end 16b opposite to the second object-side end 16a. The second camera module 16 further includes a second housing. The second housing includes a second object-side housing unit 820 and a second image-side housing unit 830 that are detachably connected. The second object-side housing unit 820 and the second image-side housing unit 830 are arranged in a direction from the second object-side end 16a to the second image-side end 16b. In some embodiments, the second arc-shaped damping portion 800 and the second mating portion 810 are both provided on the second image-side housing unit 830.

In some embodiments, the second camera module 16 further includes a second lens assembly 840 disposed in the second housing. In some embodiments, two second lens assemblies 840 are provided, which are respectively a visible light camera assembly and an infrared light camera assembly. An infrared fill light 850 provides infrared light for the infrared light camera assembly. As such, the second camera module 16 can be applied widely.

In some embodiments, the second camera module 16 further includes a second microphone 860 disposed in the second housing. As such, the second camera module 16 has both a capturing function and a sound recording function. In some embodiments, the second camera module 16 further includes a second speaker 870 disposed in the second housing. As such, the second camera module 16 can further have a voice function. In some embodiments, the second lens assembly 840, the infrared fill light 850, the second microphone 860, the second speaker 870, etc. are all integrated on a second main board 880.

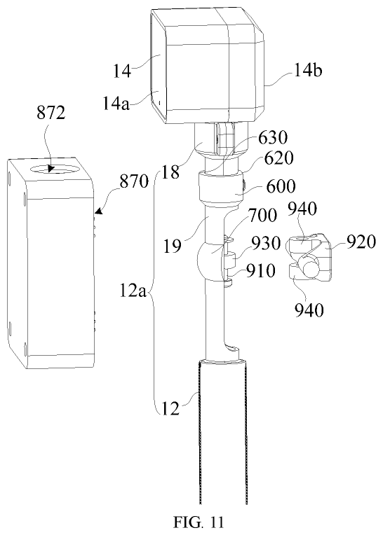

In some embodiments, as shown in FIG. 11, the second camera module 16 includes a passage 870 for the second cylinder 600 to extend through. Both ends of the passage are respectively through holes 872 disposed on the second housing. The front and rear outer walls of the second cylinder 600 are a second lower limiting portion 620 and a second upper limiting portion 630, respectively. During that the second camera module 16 rotates up and down around the fourth rotation axis D relative to the stand 12, when an inner wall of the through hole 872 of the second camera module 16 abuts against the second lower limiting portion 620, the second camera module 16 is in the state of the maximum downward rotation angle, and when the inner wall of the through hole 872 of the second camera module 16 abuts against the second upper limiting portion 630, the second camera module 16 is in the state of the maximum upward rotation angle.

In some embodiments, as shown in FIG. 10, the stand 12 has a hollow structure. A signal transmission line of the first camera module 14 is transmitted from the first cylinder 400 into the second cylinder 600, and then enters the second camera module 16 through the gap 610 (an upper half portion), bypasses the fixed portion 930 and the rotating portion 940, and then enters the second cylinder 600 through the gap 610 (a lower half portion), and finally enters the stand 12 through the second cylinder 600. A signal transmission line of the second camera module 16 enters the second cylinder 600 through the gap 610 (the lower half portion), and finally enters the stand 12 through the second cylinder 600.

In some embodiments, as shown in FIG. 11, when the whole of the first connecting structure 18, the second connecting structure 19, and the stand 12 is designated as the stand 12a, the first camera module 14 is disposed on an upper end of the stand 12a, and the second camera module 16 extends through the stand 12a.

The technical features of the above-described embodiments can be combined arbitrarily. To simplify the description, not all possible combinations of the technical features in the above embodiments are described. However, all of the combinations of these technical features should be considered as being fallen within the scope of the present disclosure, as long as such combinations do not contradict with each other.

The foregoing embodiments merely illustrate some embodiments of the present disclosure, and descriptions thereof are relatively specific and detailed. However, it should not be understood as a limitation to the patent scope of the present disclosure. It should be noted that, a person of ordinary skill in the art may further make some variations and improvements without departing from the concept of the present disclosure, and the variations and improvements falls in the protection scope of the present disclosure. Therefore, the protection scope of the present disclosure shall be subject to the appended claims.

What is claimed is:

1. A stand-type camera device, comprising:
a stand extending in an up-down direction;
a first camera module disposed on the stand; and
a second camera module disposed on the stand, and spaced apart from the first camera module in the up-down direction;
wherein the first camera module has at least two rotation modes of left-right rotation and up-down rotation relative to the stand, a first rotation axis around which the first camera module rotates left and right is parallel to the up-down direction, a second rotation axis around which the first camera module rotates up and down is perpendicular to the up-down direction;
the second camera module has at least two rotation modes of left-right rotation and up-down rotation relative to the stand, a third rotation axis around which the second camera module rotates left and right is parallel to the up-down direction, a fourth rotation axis around which the second camera module rotates up and down is perpendicular to the up-down direction.

2. (canceled)

3. The stand-type camera device according to claim 1, wherein the second rotation axis is perpendicular to a direction from an object-side end of the first camera module to an image-side end of the first camera module;
the fourth rotation axis is perpendicular to a direction from an object-side end of the second camera module to an image-side end of the second camera module.

4. (canceled)

5. The stand-type camera device according to claim 1, further comprising a first connecting structure connecting the first camera module and the stand, and wherein the first connecting structure comprises a first spherical portion and a first mating portion, the first spherical portion is disposed on one of the first camera module and the stand, and the first mating portion is disposed on the other one of the first camera module and the stand;
the first mating portion is provided with an accommodating groove extending in the up-down direction, the first spherical portion is accommodated in the accommodating groove, and the first spherical portion is capable of rotating left and right around the first rotation axis and rotating up and down around the second rotation axis in the accommodating groove.

6. The stand-type camera device according to claim 5, wherein the first connecting structure further comprises two or more first damping portions, the first damping portions are disposed on an inner wall of the accommodating groove at intervals along a circumferential direction, the first damping portions abut against the first spherical portion, so that there is a pre-tightening force between the first spherical portion and the accommodating groove, such that the first spherical portion is capable of maintaining a stable position after rotating relative to the first mating portion.

7. The stand-type camera device according to claim 5, wherein an inner wall of the accommodating groove is provided with an arc-shaped groove, the first spherical portion is provided with a sliding portion, an end of the sliding portion away from the first spherical portion is located in the arc-shaped groove;
wherein inner walls at both ends of the arc-shaped groove are a first left limiting portion and a first right limiting portion, respectively; during that the first camera module rotates left and right around the first rotation axis relative to the stand, when the sliding portion abuts against the first left limiting portion, the first camera module is in a state of a maximum left rotation angle, and when the sliding portion abuts against the first right limiting portion, the first camera module is in a state of a maximum right rotation angle.

8. (canceled)

9. The stand-type camera device according to claim 5, wherein the first camera module is located outside the accommodating groove, an end of a side wall of the accommodating groove adjacent to the first camera module comprises a first lower limiting portion and a first upper limiting portion, during that the first camera module rotates up and down around the second rotation axis relative to the stand, when the first camera module abuts against the first lower limiting portion, the first camera module is in a state of a maximum downward rotation angle, and when the first camera module abuts against the first upper limiting portion, the first camera module is in a state of a maximum upward rotation angle.

10. (canceled)

11. The stand-type camera device according to claim 1, further comprising a first connecting structure connecting the first camera module and the stand;
wherein the first connecting structure comprises a sliding portion and a first mating portion, the sliding portion is disposed on one of the first camera module and the stand, and the first mating portion is disposed on the other one of the first camera module and the stand;
the first mating portion is provided with an accommodating groove extending in the up-down direction, an inner wall of the accommodating groove is provided with an arc-shaped groove cooperated with the sliding portion, the sliding portion adapts to the arc-shaped groove, so that the sliding portion is capable of rotating left and right around the first rotation axis and rotate up and down around the second rotation axis relative to the first mating portion.

12. The stand-type camera device according to claim 11, further comprising a first spherical portion and a first damping portion;
the sliding portion is disposed on the first spherical portion, and an end of the sliding portion away from the first spherical portion cooperates with the arc-shaped groove; the first spherical portion is accommodated in the accommodating groove, and is capable of rotating left and right around the first rotation axis and rotating up and down around the second rotation axis, relative to the first mating portion along with the sliding portion; two or more first damping portions are provided, the first damping portions are disposed on an inner wall of the accommodating groove at intervals along a circumferential direction, the first damping portions abut against the first spherical portion, so that there is a pre-tightening force between the first spherical portion and the accommodating groove, such that the first spherical portion is capable of maintaining a stable position after rotating relative to the first mating portion.

13-14. (canceled)

15. The stand-type camera device according to claim 1, further comprising a second connecting structure connecting the first camera module and the stand, the second camera module being sleeved on the second connecting structure, wherein the second connecting structure comprises:
a second cylinder, both ends of the second cylinder being connected to the first cameral module and the stand, respectively; and
a rotating shaft mechanism comprising a first rotating shaft and a second rotating shaft, wherein the first rotating shaft extends in the up-down direction and is fixed on the second cylinder; an extending direction of the second rotating shaft is perpendicular to the up-down direction, and the second rotating shaft is rotatably connected to the first rotating shaft, such that the second rotating shaft is capable of rotating left and right around the third rotation axis relative to the first rotating shaft; the second rotating shaft is rotatably connected to the second camera module, such that the second camera module is capable of rotating up and down around the fourth rotation axis relative to the second rotation rotating shaft.

16. (canceled)

17. The stand-type camera device according to claim 15, wherein the second cylinder has a hollow structure, a side wall of the second cylinder is provided with a gap, and forms a second left limiting portion and a second right limiting portion;
the first rotating shaft is disposed in the second cylinder and exposed at the gap, both ends of the second rotating shaft respectively extend to an outside of the second left limiting portion and the second right limiting portion;
during that the second camera module rotates left and right around the third rotation axis relative to the stand, when the second rotating shaft abuts against the second left limiting portion, the second camera module is in a state of a maximum left rotation angle, and when the second rotating shaft abuts against the second right limiting portion, the second camera module is in a state of a maximum right rotation angle.

18. The stand-type camera device according to claim 15, wherein a second mating portion is provided in the second camera module, the second mating portion is provided with a mating hole; two second mating portions are provided, both ends of the second rotating shaft are respectively inserted into mating holes of the two second mating portions and are rotatably connected to the second mating portions; the second mating portion is capable of rotating up and down around the fourth rotation axis relative to the second rotating shaft.

19. The stand-type camera device according to claim 18, wherein the second mating portion comprises a mounting seat disposed in the second camera module and a cover plate detachably connected to the mounting seat; an end surface of the mounting seat is provided with a first groove, the cover plate is provided with a second groove; the first groove cooperates with the second groove to form the mating hole.

20. The stand-type camera device according to claim 15, wherein the second connecting structure further comprises a second spherical portion and a second damping portion; the second spherical portion is disposed on one of the second camera module and the second cylinder, the second damping portion is disposed on the other one of the second camera module and the second cylinder; the second spherical portion abuts against the second damping portion, so that there is a pre-tightening force between the second camera module and the second cylinder, such that the second camera module is capable of maintaining a stable position after rotating relative to the second cylinder.

21. The stand-type camera device according to claim 20, wherein the second spherical portion is disposed on the second cylinder, a second arc-shaped damping portion is disposed on the second camera module.

22. The stand-type camera device according to claim 20, wherein the second arc-shaped damping portion is located between two second mating portions, and the second arc-shaped damping portion and the two second mating portions are arranged in a same straight line perpendicular to the up-down direction.

23-24. (canceled)

25. The stand-type camera device according to claim 15, wherein the second camera module comprises a passage for the second cylinder to extend through; both ends of the passage are respectively through holes disposed on a housing of the second camera module; front and rear outer walls of the second cylinder are a second lower limiting portion and a second upper limiting portion, respectively; during that the second camera module rotates up and down around the fourth rotation axis relative to the stand, when an inner wall of the through hole of the second camera module abuts against the second lower limiting portion, the second camera module is in a state of a maximum downward rotation angle, and when the inner wall of the through hole of the second camera module abuts against the second upper limiting portion, the second camera module is in a state of a maximum upward rotation angle.

26-27. (canceled)

28. A stand-type camera device, comprising:
a stand;
a first camera module disposed on the stand, and capable of rotating around a first rotation axis and a second rotation axis relative to the stand, respectively; the first rotation axis forming a first preset angle with the second rotation axis, the first rotation axis being not parallel to the second rotation axis; and
a second camera module disposed on the stand, and spaced apart from the first camera module, wherein the second camera module is capable of rotating around a third rotation axis and a fourth rotation axis relative to the stand, respectively; the third rotation axis forms a second preset angle with the fourth rotation axis, and the third rotation axis is not parallel to the fourth rotation axis.

29. The stand-type camera device according to claim 28, wherein a plane where the first rotation axis and the second rotation axis are located is perpendicular to a front-rear direction of the first camera module, wherein the front-rear direction of the first camera module is a direction from an object-side end of the first camera module to an image-side end of the first camera module; and/or
a plane where the third rotation axis and the fourth rotation axis are located is perpendicular to a front-rear direction of the second camera module, wherein the front-rear direction of the second camera module is a direction from an object-side end of the second camera module to an image-side end of the second camera module.

30. The stand-type camera device according to claim 28, wherein
the first rotation axis is perpendicular to and the second rotation axis; and/or
wherein the third rotation axis is perpendicular to and the fourth rotation axis.

31-34. (canceled)

35. The stand-type camera device according to claim 28, wherein
the first rotation axis is parallel to the up-down direction; and/or
the third rotation axis is parallel to the up-down direction; and/or
the second rotation axis is parallel to the fourth rotation axis.

36-59. (canceled)
